(19) United States
(12) Patent Application Publication
(10) Pub. No.: US 2006/0026458 A1
(43) Pub. Date: Feb. 2, 2006

(54) Storage device identification replication

(76) Inventors: Frederick E. Knight, Weare, NH (US); Rajiv K. Grover, Folsom, CA (US); Matthias Popp, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/909,179

(22) Filed: Jul. 30, 2004

(51) Int. Cl. G06F 11/00

(52) U.S. Cl. 714/6

(57) ABSTRACT

A system and method implemented on a storage device comprising a controller. In one embodiment, a controller identifier of the storage device's controller is combined with a logical unit number (“LUN”) associated with data stored on the storage device to produce a first value. The embodiment further comprises receiving a second value comprising a controller identifier of another storage device's controller combined with a LUN associated with data stored on the other storage device, and combining the first and second values.

### BACKGROUND

In systems containing multiple storage devices, multiple copies of the same data may be stored to implement fault tolerance. For example, two storage devices may each contain a copy of the data. If one of the storage devices fails, the data contained thereon is not lost as the copy of that data on the other storage device is still available. This type of data fault tolerance is referred to as data “mirroring.”

In at least some systems, each of the mirrored data sets is bestowed with a unique device identifier such as a World Wide Identifier (“WWID”). The system may not correctly function if the two copies of a mirrored data set are not bestowed with the same device identifier. For example, data corruption may result if each data set in the mirrored data pair is assigned different device identifiers in a system that is configured to determine that two data sets having different device identifiers contain different data.

### BRIEF SUMMARY

At least one embodiment of the invention comprises a method implemented on a storage device comprising a controller. The method comprises combining a controller identifier of the storage device's controller with a logical unit number (“LUN”) associated with data stored on the storage device to produce a first value. The method further comprises receiving a second value comprising a controller identifier of another storage device's controller combined with a LUN associated with data stored on the other storage device, and combining the first and second values.

### BRIEF DESCRIPTION OF THE DRAWINGS

For a detailed description of exemplary embodiments of the invention, reference will now be made to the accompanying drawings in which:

FIG. 1 shows a system comprising multiple storage devices in accordance with an embodiment of the invention;

FIGS. 2 and 3 show additional detail of the storage devices of FIG. 1; and

FIG. 4 illustrates a method embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

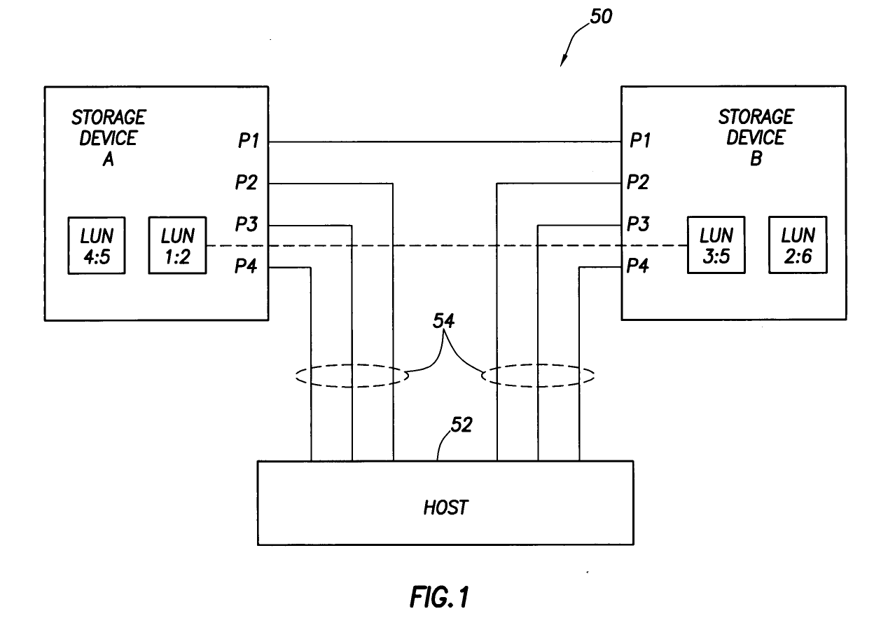

Referring now to FIG. 1, a system 50 comprises a plurality of storage devices coupled to a host 52. In the example of FIG. 1, the plurality of storage devices comprise storage device A and storage B. Additional storage devices can be included as desired. The storage devices A and B can be located in close proximity to each other (e.g., housed in a common enclosure) and/or to the host 52 or the storage devices can be located remotely from each other and/or the host 52. In general, the storage devices A and B are used to store data, programs or other types of information. The host 52 can send requests to a storage device for information contained thereon.

Each storage device A, B has multiple access points (P1-P4) by which other equipment in the system can be coupled to the storage device. In the exemplary configuration shown in FIG. 1, storage devices A and B couple to each other via access point P1 and each storage device A, B couples to the host 52 via three separate access points P2, P3, and P4. As such, host 52 can access data on each storage device across any of a plurality of paths 54. Having multiple paths for communication between the storage devices and the host 52 increases availability and bandwidth compared to having only a single communication path.

Data is organized on the storage devices in “logical units.” In some embodiments, a logical unit is a logical representation of physical storage. In some architectures, storage space can be made up of storage on multiple disk drives. A logical unit represents such storage, although it is not limited to multiple drive storage scenarios. Each logical unit is assigned a logical unit number (“LUN”). FIG. 1 shows that storage device A has two logical units identified as LUNs 1:2 and 4:5. Similarly, storage B has two logical units identified as LUNs 3:5 and 2:6. More or less than two logical units can be provided in each storage device. The dashed line between LUN 1:2 in storage device A and LUN 3:5 indicates that the data associated with those two logical units is generally the same. The data in each logical unit may be, for example, a mirrored copy of the data in the corresponding logical unit. Storage device A's LUN 4:5, however, is not a copy of storage device B's LUN 2:6.

For the host 52 to access a logical unit, the host uses a unique device identifier associated with the target logical unit. In some embodiments, the device identifier may be a world wide identifier (“WWID”). For the host to correctly access and use mirrored data (e.g., LUNs 1:2 and 3:5 in storage devices A and B, respectively), each logical unit of the mirrored pair must be instilled with the same unique device identifier. The subject matter provided herein describes a suitable technique for instilling the same unique device identifier in each logical unit in a mirrored pair. The technique described herein may apply to redundant data configuration besides data mirroring such as any of a variety of implementations of the redundant array of independent disk (“RAID”) configurations (e.g., RAID0, RAID1, etc.).

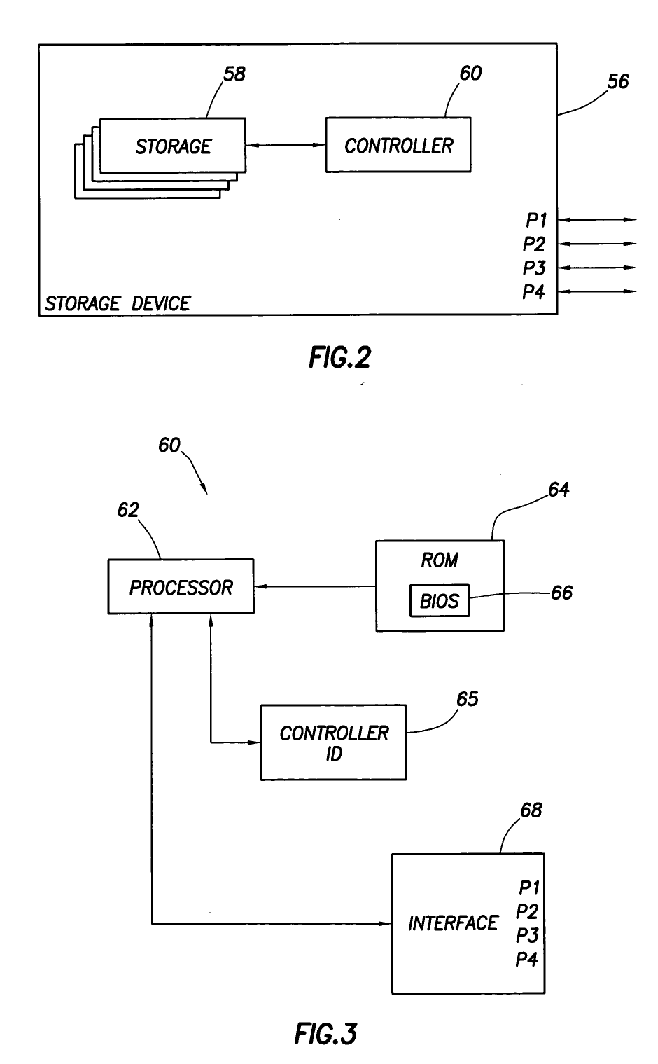

FIG. 2 shows a hardware configuration that can implemented for either or both storage devices A and B. The storage device 56 depicted in FIG. 2 comprises one or more storage media 58 coupled to, or otherwise accessible by, a controller 60. The controller 60 generally controls the operation of the storage media 58 such as the reading of data from and writing of data to the storage media 58.

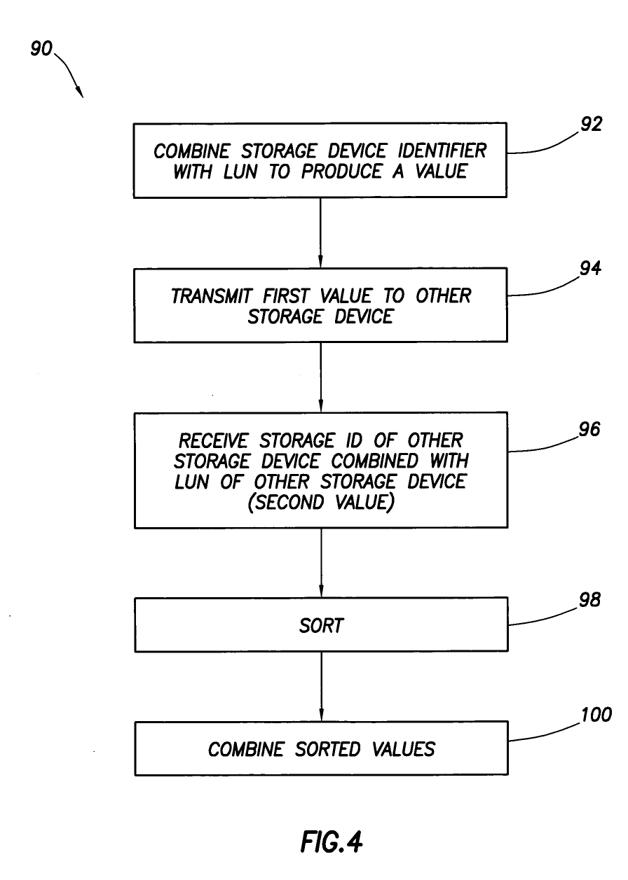

FIG. 3 depicts an exemplary embodiment of controller 60. As shown, the storage controller 60 comprises a processor 62, a read only memory (“ROM”) 64, and an interface 68. The processor 62 comprises any suitable processor capable of executing code such as a basic input/output system (“BIOS”) 66 stored in ROM 64. The BIOS 66 comprises code adapted to be executed by processor 62 to cause the processor to perform one or more or all of the actions depicted in a method embodiment such as that illustrated in FIG. 4 (described below). The interface 68 comprises logic that interfaces the plurality of access points (e.g., P1-P4) to the processor 62.

A controller identifier 65 is associated with the storage device. The controller identifier 65 uniquely distinguishes the controller in one storage device from controllers in other storage devices. In some embodiments, the controller identifier may comprise a serial number assigned by the manufacturer of the controller 60. The controller identifier can be a value other than a serial number such as an Internet Protocol (“IP”) address or media access control (“MAC”) address. If system 50 is implemented as a Fibre Channel Network, “WWName” can also be used as the controller identifier. The controller identifier 65 may be stored in a storage location in the ROM 64 or in separate non-volatile storage located elsewhere in the storage device.

FIG. 4 provides a method 90 that, in at least some embodiments, is implemented by each of a plurality of storage devices containing copies of a common data set (e.g., a mirrored logical unit pair). The method 90 is performed for each of a plurality of corresponding logical units for which the same unique identifier should be associated. Thus, if storage devices A and B have multiple sets of mirrored logical units, method 90 is performed for each such mirrored set. Further, the method 90 is performed by both storage devices containing a mirrored logical unit (or a logical unit containing redundant data in forms other than mirrored data as noted above). Method 90 may be performed after the storage devices power up in a connected state, exchange controller identifiers, establish LUN associations, and exchange LUN identifiers. Further, the method 90 may be performed upon or after a host requests a WWID from a LUN.

Method 90 may be implemented by the processor 62 executing BIOS 66 of a storage device. The functions depicted in blocks 92-100 can be performed in an order other than that shown in FIG. 4. Further, some of the functions in two or more blocks may be performed together as a single act, and not all of the functions shown are necessary.

In block 92, method 90 includes combining the storage device's controller identifier with the LUN of that storage device's logical unit having mirrored data to produce a value. Combining the controller identifier and the LUN may be implemented by concatenating the two values. With regard to storage device A In FIG. 1, for example, storage device A concatenates its mirrored LUN 1:2 with the controller identifier associated with storage device A. For illustration purposes, assuming storage device A has a controller identifier of “1234,” storage device A produces a value of “1234-1:2.” Similarly, storage device B concatenates its mirrored LUN 3:5 with the controller identifier associated with storage device B. Assuming storage device B has a controller identifier of “5678,” storage device B produces as its value “5678-3:5.”

In block 94, the value produced as a result of block 92 is transmitted to the other storage device(s) containing the corresponding (e.g., matching) logical unit. Accordingly, storage devices A and B exchange the values each storage device generated in block 92 (“1234-1:2” and “5678-3:5”). In block 96, each storage device thus receives a value from the other storage device that contains the corresponding logical unit in the mirrored pair. The value received from the other storage device represents the other storage device's controller identifier (e.g., serial number of the controller) combined with that other storage device's LUN. For example, storage device A receives the value “5678-3:5” from storage device B, and storage device B receives the value “1234-1:2” from storage device A.

In block 98, each storage device sorts its own value produced in block 92 with the value received from the other storage device. The act of sorting these values may comprise arranging the values, for example, in alphanumeric order. In the example above, each storage device A and B has two values “1234-1:2” and “5678-3:5.” In block 100, the storage device combines together the sorted values from block 98. The act of combining the sorted values in block 100 may be implemented by concatenating the sorted values. Sorting and concatenating these values by each storage device may result in a sorted value of “1234-1:25678-3:5” in each storage device in the example above. The resulting value produced by block 100 is used as the device identifier for the logical unit of the storage device.

Because each storage device performs the same acts (blocks 92-100) and exchanges its values with the other storage device, each storage device ultimately generates the same device identifier for each member of the corresponding logical units.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method implemented on a storage device comprising a controller, comprising:
combining a controller identifier of the storage device's controller with a logical unit number (“LUN”) associated with data stored on the storage device to produce a first value;
receiving a second value comprising a controller identifier of another storage device's controller combined with a LUN associated with data stored on the other storage device; and
combining the first and second values.

2. The method of claim 1 further wherein combining the controller identifier of the storage device with the LUN associated with data stored on the storage device comprises concatenating the controller identifier and the LUN.

3. The method of claim 1 further comprising sorting the first and second values prior to combining the first and second values.

4. The method of claim 1 wherein combining the first and second values comprises concatenating the first and second values.

5. The method of claim 1 further comprising transmitting the first value to the other storage device.

6. The method of claim 1 further comprising using the combined first and second values as a device identifier for the data associated with the unit identifier.

7. The method of claim 6 further comprising transmitting the device identifier to a host for subsequent use to access said data.

8. The method of claim 1 further comprising transmitting the combined first and second values to a host for subsequent use to access said data.

9. A system, comprising:
at least a first storage device comprising a controller and coupled to a host; and
at least a second storage device comprising a controller and coupled to said host;
wherein the first storage device combines a controller identifier of the controller in the first storage device with a logical unit number (“LUN”) associated with data stored on the first storage device to produce a first value, and combines the first value with a second value received from the second storage device.

10. The system of claim 9 wherein the first storage device sorts the first value and the second value.

11. The system of claim 9 wherein the controller identifier comprises a serial number of the controller in the first storage device.

12. The system of claim 9 wherein the combined first and second values are used as a device identifier for a logical unit in the first storage device.

13. The system of claim 12 wherein the device identifier comprises a world wide identifier (“WWID”).

14. The system of claim 12 wherein the logical unit in the first storage comprises data that is common to a logical unit in the second storage device.

15. The system of claim 9 wherein the second storage device receives the first value from the first storage device and uses the first value to produce a device identifier associated with a logical unit in the second device that is the same as the device identifier for the logical unit in the first storage device.

16. A storage device, comprising:
a controller; and
a storage medium coupled to said controller and adapted to store a logical unit;
wherein said controller combines a controller identifier of said controller with a logical unit number (“LUN”) to generate a first value, and combines the first value with a second value generated by another storage device to form a device identifier used by host logic to access said logical unit, said second value generated using a controller identifier associated with the other storage device and a LUN associated with a logical unit contained in the other storage device.

17. The storage device of claim 16 wherein said controller sorts the combined first and second values.

18. The storage device of claim 16 wherein said controller combines its controller identifier with a LUN by concatenating the controller identifier and LUN.

19. The storage device of claim 16 wherein the storage device transmits the first value to the other storage device to be used by the other storage device to generate a device identifier that is the same as the device identifier used by the host logic.

20. The storage device of claim 16 wherein the controller combines the first and second values by concatenating the first and second values.

21. The storage device of claim 16 wherein the controller combines the first and second values by placing the first and second values in a predetermined order and concatenating the ordered first and second values.

22. A storage device, comprising:
means for storing logical units; and
means for forming a device identifier for a logical unit based on information in the storage device and information received from another storage device, said device identifier being identical to a device identifier formed in the other storage device;
said information comprising at least a logical unit number and a controller identifier.

23. The storage device of claim 22 wherein said means for forming the device identifier comprises means for concatenating a logical unit number associated with a logical unit with a unique identifier associated with the means for forming the device identifier.

24. The storage device of claim 22 wherein said means for forming the device identifier comprises means for combining the information in the storage device and the information received from the other storage device.
